(19) United States
(12) Patent Application Publication
(10) Pub. No.: US 2017/0029197 A1
(43) Pub. Date: Feb. 2, 2017

(54) BOTTLE AND PRODUCTION METHOD THEREOF

(71) Applicant: QUALIPAC, Neuilly Sur Seine (FR)

(72) Inventor: Gérald Martines, Paris (FR)

(73) Assignee: QUALIPAC, Neuilly Sur Seine (FR)

(21) Appl. No.: 15/302,800

(22) PCT Filed: Apr. 8, 2015
(86) PCT No.: PCT/FR2015/050915

§ 371 Date: Oct. 7, 2016

(30) Foreign Application Priority Data
Apr. 8, 2014 (FR) 14 53107

(51) Int. Cl. B65D 81/32; B65D 1/04; B05B 11/00; A45D 40/24; A45D 34/02; B65D 1/02; B65D 55/02

(52) U.S. Cl. CPC B65D 81/3283; B65D 1/023; B65D 1/04; B65D 1/0207; B65D 55/02; A45D 40/24; A45D 34/02; B05B 11/0037; B05B 11/3085

(57) ABSTRACT

A bottle comprising: a first glass container equipped with a first mouth; a second glass container, different and separate from the first glass container and equipped with a second mouth; a closure system that is permanently and non-removably assembled to both the first mouth of the first glass container and the second mouth of the second glass container in a sealed manner; and a product dispensing system providing access to any product contained in the receptacle.

The invention relates to the field of bottles and their production methods.

The term “bottle” is used here to designate a rigid object intended to hold fluid content (liquid, viscous, or pasty) to be dispensed. Such a bottle may have a closed and sealed configuration in which the fluid cannot freely leave the bottle. Such a bottle may also be placed in a dispensing configuration, in which the content is dispensed from the bottle. Such bottles are used in the field of cosmetics or spirits.

In the field of packaging, other types of containers exist besides bottles. As an illustration, one can refer to the cans described in US 2010/065,557 for an example of other types of containers.

Rigid plastic bottles exist which allow great freedom in their shape or production method. For example, FR 2813291 describes a bottle which can be connected temporarily to a “travel size” bottle in order to fill the “travel size” bottle from the main bottle. Another example of a plastic product is U.S. Pat. No. 6,135,523 for example. Plastic bottles are not suitable for some market segments, however, where bottles including a glass container are traditionally used. However, glass is a material that is difficult to implement from an industrial point of view, due to its demanding manufacturing process (in particular the high temperatures), which can result in wide dispersion in the resulting products due to manufacturing tolerances. This wide dispersion poses problems when it comes to achieving reliable and durable fluidtightness of the bottle in its closed configuration. To reduce these problems, a blowing process is traditionally used which allows defining a glass container of large capacity, with a narrow neck where the sealing function is implemented. As the glass neck is narrow, it is possible to oversize the sealing solution to ensure that a fluidtight bottle is provided despite the dispersion in the manufacturing process.

Recently, there have been efforts to move away from the traditional shape of glass bottles with a narrow neck. A process called “direct press” was presented in EP 2602 232. This process can certainly be supplemented with a blowing step where appropriate, but the basic geometry of the glass container is still able to have a large opening in comparison to traditional necks. With such large openings, sealing issues become complex. This direct press method also allows providing different cross-sectional profiles of the opening, and in particular non-circular profiles. For such profiles, due to the non-uniformity of the periphery, the sealing issues are again complex.

FR 2,840,888 provides an example of a container comprising either a single cylindrical body, or two cylindrical bodies connected together by a reinforcing plate. The component material primarily described for the cylindrical bodies is polypropylene, although a long list of possible materials is given. The contents are held in flexible pouches assembled to the dispensing system. Outside air is allowed to enter the space between the flexible pouch and the outer wall. In the dispensing system, valves are provided to close off the air circuit when the pump is not actuated. For the implementation involving a reinforcing plate, the use of such valves at the connection between the reinforcing plate and the cylindrical body is neither contemplated nor feasible.

Furthermore, there is always a search for ways to diversify bottle product lines and enhance existing bottles with new features, to enable the development of innovative products.

A description of the invention is provided below.

The invention relates to a bottle comprising:
a first sub-bottle comprising a first glass container body, comprising a first mouth,
a second sub-bottle, distinct and separate from the first sub-bottle, comprising a second glass container body that is distinct and separate from the first glass container body, and comprising a second mouth,
a closure system that is sealingly assembled in a permanently and non-removable manner to both the first mouth of the first glass container body and the second mouth of the second glass container body, the closure system and the first and second sub-bottles being assembled so as to define at least one receptacle,
a product dispensing system providing access to a product that may be contained in the at least one receptacle.

With these arrangements, a bottle having a glass container body is provided that is therefore suitable for the applications referred to above, while offering a wide variety in terms of shape.

The product dispensing system is provided in at least one among the first glass container body, the second glass container body, and the closure system.

In one embodiment, the closure system comprises a sealing system assembled to each of the first and second glass container bodies, and a locking system clasping the sealing system onto each of the first and second glass container bodies.

In one embodiment, the sealing system is one piece.

In one embodiment, the sealing system is assembled by at least clipping onto at least one among the first and second glass container bodies, and in particular onto each of the first and second glass container bodies.

In one embodiment, the sealing system comprises a body and a clip portion that is elastically deformable relative to the body, and that provides an assembly contour, said at least one among said first and second glass container bodies, and in particular each of said first and second glass container bodies, comprises a contour of a shape complementary to that of the assembly contour of the clip portion, and the contours engage to hold together the sealing system and said at least one among said first and second glass container bodies, and in particular each of said first and second glass container bodies.

In one embodiment, the locking system clasps the clip portion.

In one embodiment, the first and second mouths are symmetrical to one another relative to a first plane of symmetry, and the sealing system has a plane of symmetry that is coincident with the first plane of symmetry.

In one embodiment, the first and second mouths are symmetrical to one another relative to a first plane of symmetry, and the closure system has a plane of symmetry that is coincident with the first plane of symmetry.

In one embodiment, the closure system and the first and second glass container bodies are assembled so as to define a single receptacle.

In one embodiment, the closure system and the first and second glass container bodies are assembled so as to define at least first and second receptacles that are fluidtight relative to each other, the product dispensing system

In one embodiment, the product dispensing system is arranged to allow independent access to a product that may be contained in the first and the second receptacle.

In one embodiment, the product dispensing system is arranged to allow joint access to a product that may be contained in the first and the second receptacle.

In one embodiment, the product dispensing system is arranged to prevent independent access to products that may be contained in the first and the second receptacle.

In one embodiment, the first and second glass container bodies have shapes that are symmetrical to each other relative to a plane of symmetry.

In one embodiment, the first and second glass container bodies have shapes that are asymmetrical to each other relative to a plane of symmetry.

In one embodiment, the product dispensing system provides access to a product that may be contained in the receptacle, through a dispensing opening, the mouths of the first and second glass container bodies having a cross-sectional area that is at least twice that of the dispensing opening.

In one embodiment, the bottle further comprises at least one solid object within the at least one receptacle, the object having dimensions that are between those of the cross-section of the mouth and the cross-section of the first dispensing opening.

According to another aspect, the invention relates to a production method for a bottle, which comprises:
providing a first sub-bottle comprising a first glass container body, comprising a first mouth,
providing a second sub-bottle, distinct and separate from the first sub-bottle, comprising a second glass container body that is distinct and separate from the first glass container body, and comprising a second mouth,
sealingly assembling a closure system, in a permanent, and non-removable manner, to the first mouth of the first glass container body and to the second mouth of the second glass container body, so as to define at least one receptacle,
   a product dispensing system being arranged to provide access to a product that may be contained in the at least one receptacle.

In one embodiment, when assembling the closure system:
a sealing system is assembled to each of the first and second glass container bodies, and
the sealing system is clasped onto each of the first and second glass container bodies by means of a locking system.

In one embodiment, when assembling the sealing system, the sealing system is clipped onto the first glass container body, and preferably the sealing system is then clipped onto the second glass container body.

According to one embodiment, said first glass container body and/or said second glass container body are each provided by a pressing step in which a punch is moved out of a mold cavity, through the mouth.

According to another aspect, the invention provides a bottle comprising:
a first glass container body comprising a first mouth and a second mouth,
a first closure system sealingly assembled to the first mouth of the glass container body,
a second closure system sealingly assembled to the second mouth of the glass container body, the first and second closure systems and the glass container body being assembled permanently and non-removably so as to define at least one receptacle,
a product dispensing system being arranged in at least one among the glass container body and the first and second closure systems, to provide access to a product that may be contained in the receptacle.

The figures in the drawings are now briefly described.

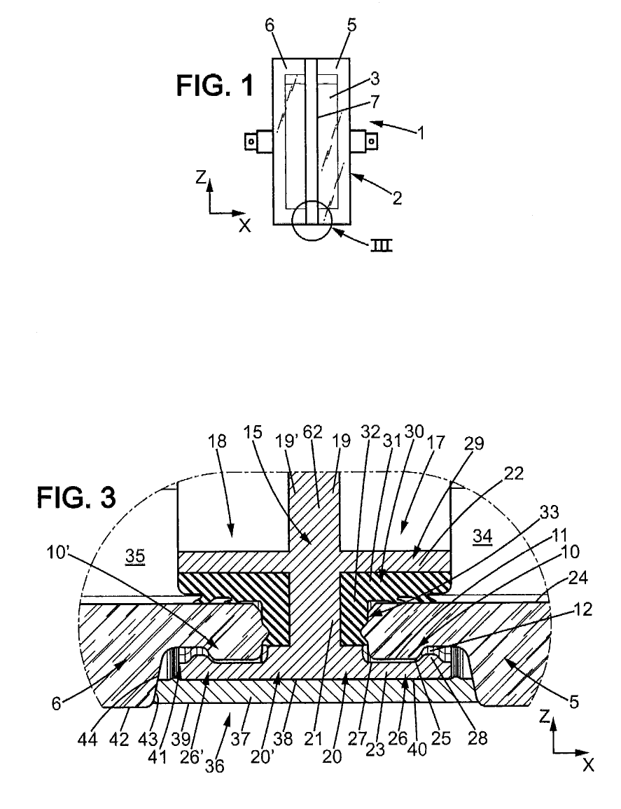

FIG. 1 is a schematic front view of a bottle according to one embodiment of the invention.

FIG. 2 is a schematic exploded perspective view of part of the bottle of FIG. 1.

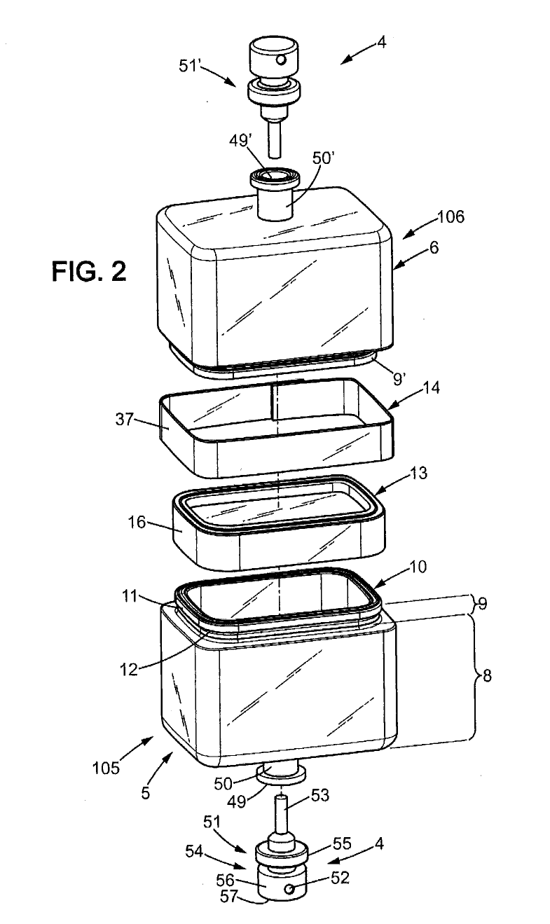

FIG. 3 is a sectional view of the detail area labeled III in FIG. 1.

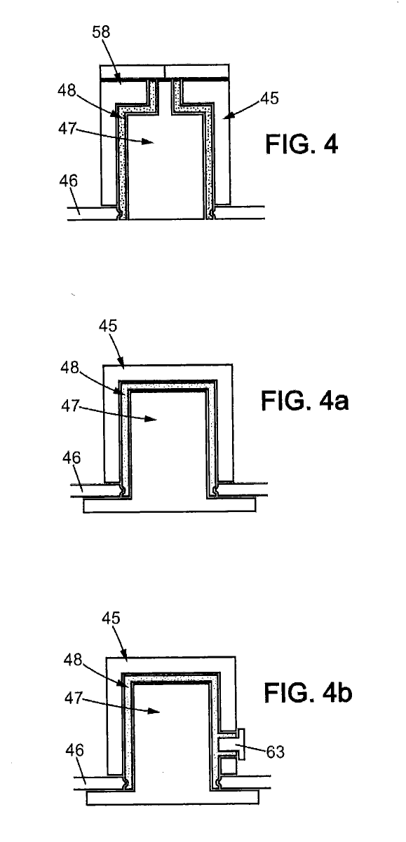

FIGS. 4, 4a, and 4b are schematic views of production methods for glass container bodies which can be implemented within the scope of the invention.

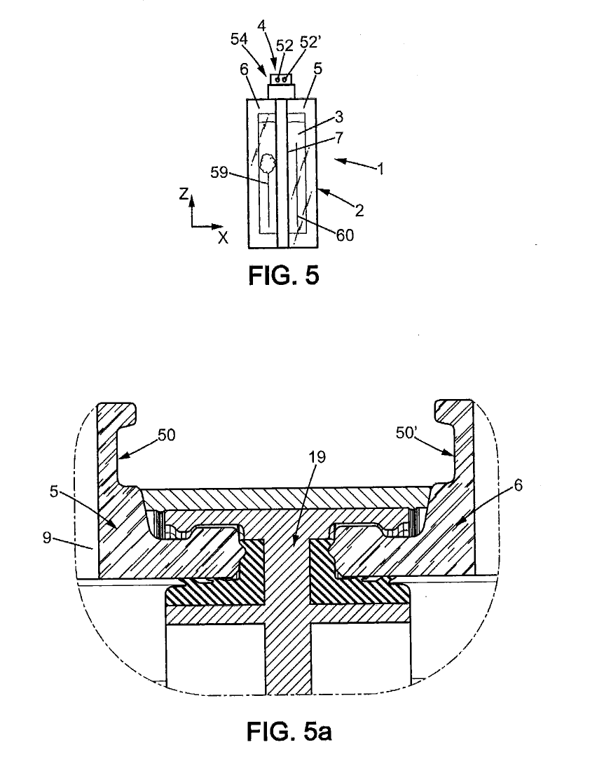

FIGS. 5, 6, 7, and 8 are views similar to FIG. 1 for other embodiments.

FIG. 5a is an illustrative detail view of the embodiment of FIG. 5.

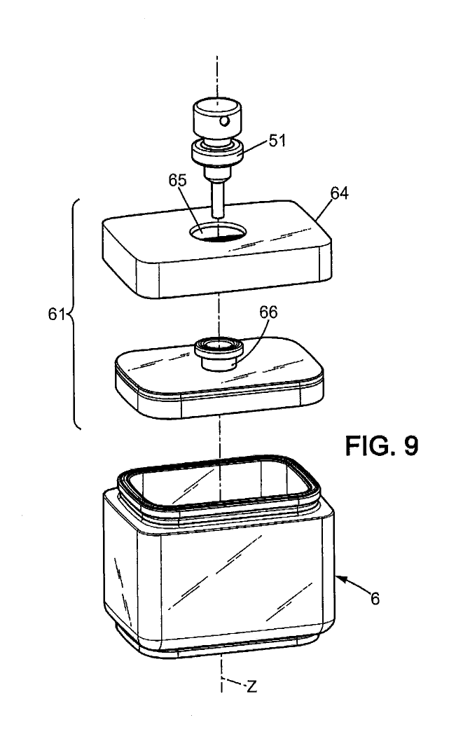

FIG. 9 is a view similar to FIG. 2, for part of the embodiment of FIG. 8.

Below is a detailed description of several embodiments of the invention, with examples and with reference to the drawings.

FIG. 1 is a schematic representation of a bottle 1. The bottle 1 comprises a closed container 2. The closed container 2 defines an interior volume capable of holding content 3. The content 3 is fluid, for example liquid or pasty, and may for example be a cosmetic product, for example a perfume, a food product, liquor, or some other product. In particular, the content 3 may be more volatile than water. The bottle 1 also includes a dispensing system 4. The dispensing system 4 is assembled to the container 2 and is suitable for dispensing the content 3 from the closed container 2. We should specify that in the example shown, the container 2 remains permanently closed during normal use of the bottle 1 by a user, and that the dispensing system 4 is the only way to dispense the content 3 from the container 2.

According to the first embodiment shown in FIG. 1, the container 2 consists of at least three distinct parts. The container 2 comprises a first sub-bottle 105, a second sub-bottle 106, and a closure system 7. The first sub-bottle 105 consists of a first glass container body 5. The second sub-bottle 106 consists of a second glass container body 6. The closure system 7 is arranged between the first and second glass container bodies 5, 6. The closure system 7 is assembled to each of the first and second glass container bodies 5, 6. When mention is made of “distinct” parts, this refers to the fact that these parts are composed of objects that can be separated from one another spatially, even if no such separation is intended during normal use of the bottle by a user, and even if such separation may be impossible or difficult once the bottle is assembled.

The following describes the first glass container body 5. The first glass container body 5 is primarily made of glass. Any type of glass compatible with the intended application may be used, including the types already currently in use in the bottle industry. As can be seen in particular in FIG. 2, the first glass container body 5 comprises a reservoir portion 8 and a mouth 9. The reservoir portion 8 and the mouth 9 are integral to one another. The reservoir portion 8 defines the major portion of the first glass container body 5. It has a suitable shape for holding the content 3. The mouth 9 extends the reservoir portion 8, and has a shape functionally defined for assembly of the first glass container body 5 with another component. In particular, the mouth 9 is adapted for assembly with the closure system 7. The mouth 9 has a specific contour 10 adapted to engage by means of its complementary shape with a complementary contour of the closure system. In the illustrative embodiment shown, the contour 10 comprises a continuous peripheral radial bead 11, and a continuous peripheral groove 12 adjacent to the bead 11 and arranged after it in what can be referred to as the assembly direction.

The mouth 9 may be a large opening. In the field of bottles, an opening is said to be large when the order of magnitude of the dimensions of the opening is similar to that of the reservoir portion 8. In particular, we distinguish between glass container bodies having a large opening from bottles made by blowing in the traditional manner, which have a narrow neck compared to the general dimensions of the glass body. A glass body with a large opening may be achieved by a pressing process, as will be described below with reference to FIGS. 4, 4a, and 4b. Note that this definition does not preclude a blowing step being implemented during manufacture of the glass container body, as long as the definition of a large opening as given above remains satisfied.

When mention is made of the shape of the cross-section of the mouth 9, this refers in particular to the sectional shape of the radially inner surface of the first container body 5 at the mouth 9, given that the external shape at the mouth 13 is functionally dictated by that of the radially inner surface, and given the functional need for a fluidtight assembly. As for the shape of the cross-section of the radially inner surface of the first container body 5 at the mouth 13, this may be any suitable shape, such as a circular or non-circular shape. It may be a polygonal shape with rounded edges, oval, ellipsoid, and in particular any manufacturable non-circular shape. For a non-circular shape, the skilled person knows the level of regularity to expect in a surface formed in a glass pressing process. A non-circular shape is considered to be such from the moment a skilled person is able to determine, when observing the shape, that it was deliberately manufactured to be non-circular. Thus, non-circular does not cover circular shapes in which shape defects due to the production method have changed the shape relative to a desired ideal geometric circle. For example, a non-circular shape will be considered to be such when there is a deviation of more than 2% between the nominal diameter of a surface in question and the diameters inscribed and circumscribed on the surface in question. A difference of more than 20% is quite possible. The shape in question is that of the inner surface, and/or the outer surface, independently of any protruding contours serving as catches, such as the bead 28.

The first glass container body 5 is also provided with a dispensing opening 49. The dispensing opening 49 is provided on the side opposite the mouth 9. The dispensing opening 49 may, for example, be characterized as a small opening in comparison to the mouth 9. The dispensing opening 49 may be provided in a typical neck 50 of glass bottles.

An exemplary closure system 7 is given in relation to FIG. 2. In this purely illustrative example, the closure system 7 is complementary to the mouth 9 of the first glass container body. The closure system 7 comprises a sealing system 13 and a locking system 14 which are distinct from one another.

The sealing system 13 comprises a body 15 and a clip portion 16 integral with the body 15. The sealing system 13 comprises two integral portions in the embodiment shown: a first portion 17 engaging with the first glass container body 5, and a second portion 18 engaging with the second glass container body 6. Only the first portion 17 will be described here. The first portion 17 comprises a body 19 and a clip portion 20. The clip portion 20 is integral with the body 19. The clip portion 20 has a shape that is substantially complementary to the first glass container body 5 at the mouth 9. In particular, the cross-section of the clip portion 20 is U-shaped with a base 21 from which two parallel arms 22 and 23 extend. Arm 22, referred to as the inner arm, is intended to be arranged opposite an inner face 24 of the first glass container body 5, and arm 23, referred to as the outer arm, is intended to be arranged facing an outer face 25 of the first glass container body 5. The outer face 25 of the first glass container body 5 is opposite the inner face 24. Thus, the clip portion 20 caps the first glass container body 5 at the mouth 9.

The outer arm 23 is connected to the base 21 so as to be elastically deformable relative thereto. The outer arm 23 provides an assembly contour 26 that is complementary to the contour 10 of the mouth 9. In particular, the inner face 27 of the outer arm 23 provides a bead 28 projecting radially inwards. In the assembled state of the first glass container body 5 with the sealing system 13, as shown in FIG. 3, the bead 28 is received in the groove 12. In this state, bead 28 cooperates with bead 11 to hold together the sealing system 13 and the first glass container body 5.

The sealing system 13 engages with the first glass container body 5 to define a fluidtight connection between these two elements. Thus, the sealing system 13 and the first glass container body 5 are in close contact to prevent the content 3 from flowing between them. The content 3 is in direct contact with the glass container body 5 and with the sealing system 13. In the purely illustrative example shown, the sealing system comprises a support part 29 and a gasket 30 carried by this support part. The gasket 30 is assembled in any suitable manner to the support part 29, in particular by overmolding. In the purely illustrative example shown, the gasket 30 closely engages with the glass container body 5. In particular, the gasket 30 may comprise an L-shaped cross-section, a first arm 31 of the L engaging with the inner face 24 of the first glass container body 5, and a second arm 32 of the L engaging with the side surface 33 of the first glass container body 5. The side surface 33 of the first glass container body connects inner face 24 and outer face 25.

Various forms and configurations of the gasket may be provided. For example, the two portions of the L are not completely joined along the periphery of the gasket, or may not be joined at all. Aside from the L shape described above, a U-shape may be provided for example, comprising the L-shape described above plus an additional arm extending from arm 32, parallel to arm 31, and applied between outer arm 23 and the outer face 25 of the glass container body 5. Where appropriate, an L-shape may alternatively be provided, defined starting from the U-shape just been described but without arm 31. In this last embodiment, the sealing system 13 of arm 22 may be eliminated. Alternatively, the gasket 30 may have a substantially triangular cross-section so that one face of said gasket is compressed against an edge of the glass container body 5 formed between side surface 33 and inner face 24.

According to one embodiment of the invention, the gasket 30 comprises at least one protruding element or sealing lip adapted to form a sealing line against the surface of the container body 5. Preferably, the at least one sealing lip has a tapered shape or has an outer surface with a partially circular cross-section.

In the example, the gasket 30 comprises two sealing lips (as shown), each capable of forming a sealing line against the inner face 24 of the container body 5.

A number of sealing lips greater than two may also be considered, particularly when the gasket 30 is configured so as to form a sealed connection between the sealing system 13 and only one among the surfaces 24, 25, or 33 of the container body 5.

When at least two sealing lips are used, they may, depending on the configuration of the gasket 30, be arranged so that each forms a sealing line against multiple surfaces 24, 25, 33 of the container body 5.

Alternatively, the body 19 and the gasket 30 are one part and are formed of the same material. This applies in particular to the case of polyethylene, or high density polyethylene. The characteristics of the gasket 30 and the embodiments detailed above can be adapted to one body 19.

For all practical purposes, the geometry shown in FIG. 3 is found in the same or similar manner all along the periphery of the first glass container body 5.

Assembly of the first glass container body 5 with the sealing system 13 defines a first closed receptacle 34 in which the interior space is accessible only by means of the dispensing system 4.

The components likely to be in contact with the content (in particular the support part 20 and the gasket 30) are chosen to satisfy requirements of compatibility (the product to be contained in the bottle does not cause deterioration of the component) and neutrality (the component does not release any compounds into the liquid product in undesirable proportions). These requirements affect the materials used for these components or their production method. The requirements may depend on the content.

We will now describe the relation between the sealing system 13 and the second glass container body 6.

In general, the above description of the relation between the sealing system 13 and the first glass container body 5 applies to the relation between the sealing system 13 and the second glass container body 6.

For example, for simplicity, we will first describe a case where the second glass container body 6 is symmetrical to the first glass container body 5 relative to a plane of symmetry Y-Z. The plane of symmetry Y-Z is orthogonal to the assembly direction. In such a case, the second portion 18 of the sealing system 13 is symmetrical to the first portion 17 of the sealing system 13 relative to the plane of symmetry Y-Z. In addition, the first and second portions 17, 18 are integral at plane of symmetry Y-Z, in other words forming a central core 62 in this example that is continuous with the base 21 of the clip portions 20 of each tier.

Thus, where appropriate, a characteristic of the second glass container body 6 is designated by the same reference symbol as the corresponding characteristic of the first glass container body 5, with the addition of the symbol. For example, the reference 9′ is used to denote the mouth of the second glass container body 6. This also applies to the closure system 7.

Thus, the bodies 19 and 19 of the first and second portions 17 and 18 together form the body 15 of the sealing system. The clip portions 20 and 20′ of the first and second portions 17 and 18 together form the clip portion 16 of the sealing system.

The assembly of the second glass container body 6 with the sealing system 13 defines a second closed receptacle 35 of which the interior space is accessible only by means of the dispensing system 4.

The closure system 7 also comprises a locking system 36. The locking system 36 clasps the sealing system 13 onto each of the first and second glass container bodies 5, 6. In a purely illustrative example, the locking system 36 comprises a peripheral rigid band 37 surrounding the sealing system 13 and maintained at a certain tension. The band 37 is, for example, a thin metal strip. More particularly, the band 37 comprises an inner face 38 and an opposing outer face 39. The inner face 38 faces the interior of the bottle. The inner face 38 presses against the outer face 40 of the sealing system 13. In particular, the inner face 38 presses against the outer face 40 of the outer arm 23. The inner face 38 of the band 37 prevents the outer arm 23 from bending out of its assembled configuration shown in FIG. 3. In particular, the inner face 38 of the band 37 prevents the outer arm 23 from bending outward, which would allow the assembly contours 10 and 26 to disengage from one another.

In the embodiment shown, which is symmetrical relative to plane Y-Z, the above description applies both to the arm 23 of the first portion 17 and to that of the second portion 18. The band 37 is one piece at the plane of symmetry Y-Z.

In one example, the band 37 is housed in a recess 41 defined within the general geometric casing of the first and second glass container bodies 5, 6. The side surface 43 of the strip 37, connecting the inner 38 and outer 39 faces thereof, is in contact with a shoulder 44 of the first/second glass container body 5, 6. This configuration limits the deposit of dust or foreign bodies. It may be arranged that outer face 39 is flush with outer face 42 of the first and second glass container bodies 5, 6. This arrangement prevents free access to the protruding edges of the bottle.

The embodiment presented above is said to be symmetrical relative to plane Y-Z. Note that as an alternative, one could have an embodiment that is not symmetrical relative to plane Y-Z. An example of such an embodiment includes a second glass container body 6 of which only the mouth is symmetrical with the mouth 9 of the first glass container body, relative to plane Y-Z. In this case, we can use the same closure system as described above. The reservoir portion of the second glass container body 6 may be of any shape as long as it can be manufactured and formed integrally with the mouth of the second glass container body. When the phrase “any shape” of the reservoir portion is used, this may refer to the inner shape as well as to the outer shape thereof. Thus, bottles of highly varied shapes can be achieved with the invention.

Alternatively, the mouths of the first and second glass container bodies 5, 6, and the closure system 7 are not necessarily symmetrical relative to the Y-Z plane, as long as there can be fluidtight closure of the two containers. In particular, the first and second glass container bodies may have asymmetrical shapes.

The dispensing system 4 comprises a dispensing member 51. The dispensing member 51 may, for example, be a pump. The dispensing member 51 is assembled onto the glass container body 5 by any suitable means. For example, the dispensing member 51 is crimped onto the neck 50. Alternatively, it is possible for example to use snap-fastening or screwing. The dispensing system 4 may comprise a dip tube assembled to the dispensing member 51 and providing access to the product contained inside the container 2.

According to a schematic exemplary embodiment, the dispensing member 51 comprises a first product outlet 52, a first tube 53 adapted to guide the product which may be contained in the first receptacle 34 to the first product outlet 52, and a first actuator 54 which can be actuated by a user to control release of this product through the first product outlet 52.

The first actuator 54 comprises a base 55 fixed to the glass container body, and a member 56 that is movable relative to the base 55 and comprising an actuation region 57 accessible to a user which can be actuated to control the release of first product, the movable member 56 providing the first product outlet 52.

The bottle which has just been described may be created as follows:

As is represented highly schematically in FIG. 4, a mold for the body 45, a mold for the large opening 46, and a punch 47 are used, together forming a cavity receiving a glass gob 48. The punch 47 is movable relative to molds 45 and 46, between a withdrawn position and an extended position in which the cavity defines the future shape of the first glass container body 5. One can see that the first glass container body 5 therefore has a large opening to allow the passage of the punch 47. The punch 47 defines the internal shape of the first glass container body 5, and the molds its external shape. The mold for the large opening 46 can be used to shape the mouth 9 of the first glass container body 5. The bottom 58 of the mold for the body 45 can be used to shape the neck 50 of the first glass container body 5.

Where appropriate, the pressing step described below is followed by a blowing step, in which the reservoir portion 8 is reshaped by blowing into its internal volume. This blowing step can increase the internal volume of the bottle by about 10% to 20%, if one wishes to maintain the geometrical characteristics of the inside surface that were obtained during the pressing step. The term “pressed” as used here refers to any implementation that comprises a pressing step, including cases where this step is followed by a blowing step, as long as the other requirements of the invention are met.

The neck 50 is completed in a trepanning step that generates the opening in the neck.

The second glass container body 6 can be created by the same method, using the same tooling, in which case the first and second glass container bodies 5, 6 will have identical shapes, in particular shapes symmetrical with respect to the interface plane, or with different tooling, in which case the first and second glass container bodies may have different shapes, in particular symmetrical to one another relative to a plane of symmetry, or with mouths that are symmetrical to each other relative to a plane of symmetry.

As represented in FIG. 2, the first glass container body 5 and the second glass container body 6 are assembled to the closure system. In particular, the first glass container body 5 is assembled to the sealing system 13. This assembly can be done by snap-fitting. During snap-fitting, arm 23 is elastically deformed by peripheral bead 11 during the relative movement of the first glass container body 5 and the closure system, until bead 25 enters groove 12, which releases the stress previously generated in arm 23. For example, the first glass container body and the sealing system 13 are moved toward one another linearly along an assembly direction, but progressive

The second glass container body 6 may now be assembled to the sealing system 13 (which has already been assembled to the first glass container body 5). One can proceed in the same manner as above, for example by snap-fitting.

Where appropriate, the first and second glass container bodies 5 and 6 are simultaneously assembled to the sealing system 13.

The sealing system 13 is considered to be a single piece, whether it is created as a one-piece part, or as one or more part(s) overmolded by a gasket, or as a system comprising the part(s) and the gaskets compressed between the part and the corresponding glass container body. Alternatively, the sealing system could be created as two parts, each providing a sealed connection with a respective glass container body, and then assembled together in a fluidtight manner; among other possibilities, this embodiment allows unrelated shapes of the mouths of the first and second glass container bodies and enables asymmetrical assemblies.

Next, the locking system 14 is mounted on the previously assembled assembly. In particular, the sealing system 13 is clasped with the locking system 14. For example, a band 37 is provided which has two free ends. The sealing system 13 is surrounded with the band 37 and traction is applied to the band until satisfactory tension is obtained, then the two end portions of the band are secured together in this position, keeping the band 37 taut.

It is possible to fill a receptacle with the desired product. The content 3 is then directly in contact with the glass body of the receptacle and with the sealing system 13. Next, the receptacle is closed by assembling a dispensing member onto the respective neck, and the same is done for the other receptacle.

The two dispensed products may differ from one another in one or more characteristics, such as chemical composition (nature or proportion of components), density, dilution factor, viscosity, etc.

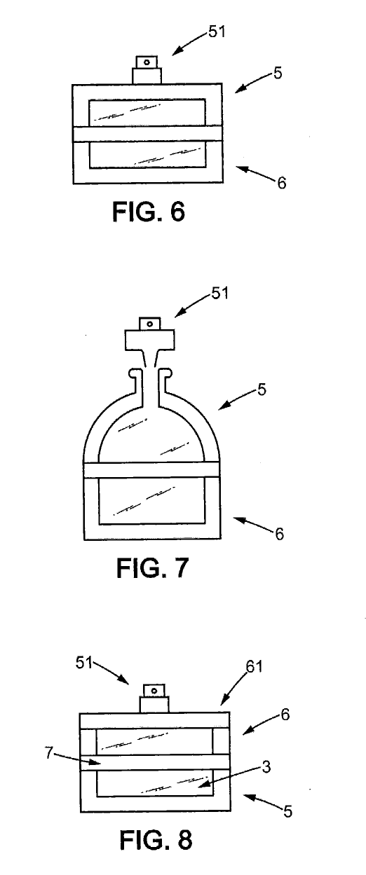

Alternatively, the bottle forms a single receptacle. In this case, it contains a single product to be dispensed. A product to be dispensed that is considered a single product is one which may contain a mixture of several chemical compounds, but of a composition in the bottle, for example homogeneous, that has been appropriately verified for the intended application. It is sufficient for the body 15 to have a through-opening allowing the content 3 to circulate. In this case, only one dispensing member 51 may be used. For example, two glass container bodies 5, 6 of similar interfaces are provided, but differing in that the first glass container body 5 has a neck 50 as described above to which is assembled a dispensing member, but the second glass container body 6 has only one opening, at the mouth 9′ (in this example, the second glass container body does not comprise a neck 50′ or opening 49′). An exemplary embodiment is represented in FIG. 6. The mold used to form the second glass container body is shown in FIG. 4a. This differs primarily from the mold of FIG. 4 by the shape of the bottom of the cavity for the body 45, which is adapted so that a neck 50′ is not formed.

In such an embodiment, it is also possible to place an object, for example a decorative object, inside the bottle. The object is, for example, rigidly fixed to the closure system, in particular to the sealing system, in particular to the body 15 thereof. The object is of dimensions which prevent its exit through a product dispensing opening, but allowing its placement through the mouth of the glass container bodies.

FIG. 7 illustrates a similar embodiment, where the glass container bodies 5, 6 have very different shapes. Glass container body 6 comprises, for example, a reservoir portion 8 having a generally cylindrical shape, and glass container body 5 comprises, for example, a reservoir portion 8 having a generally hemispherical shape, such that their respective wide mouths can have a similar annular shape.

Thus, according to the examples, at least two glass container bodies have one or more (if they are compatible) of the following characteristics:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

FIG. 5 shows a variant of the embodiment of FIG. 1. In this example, two receptacles are again provided that are assembled to each other in a fluidtight manner. The dispensing system 4 is a joint dispensing system for both receptacles simultaneously. The first and second product outlets 52, 52 are provided by a common actuating member 54, and are respectively connected to each of the receptacles by means of a tube. The locking part 36 may have a local opening to permit mounting the dispensing system on it.

An implementation of the dispensing system is represented in FIG. 5a. The dispensing system 4 is assembled directly onto the glass container bodies 5, 6. This is done for example in the known manner for assembling a dispensing member to a glass container body. The first glass container body 5 has a neck 50 that is created as a glass neck is typically created on a glass container body. The neck 50 is formed in a peripheral wall of the first glass container body. The dispensing member 51 is assembled onto the neck 50 in an appropriate manner, for example by crimping, snap-fitting, or screwing. One can proceed in the same manner for the second glass container body 6, which has a neck 50′ onto which dispensing member 51′ is assembled. For example, the same type of assembly is performed as for the assembly of the first dispensing member 51 onto the first glass container body 5. For example, the necks 50, 50′, and consequently the dispensing members 51, 51, are provided in a manner that is symmetrical relative to the center plane of the bottle 1. If joint actuation of two dispensing members 51, 51′ is planned, as represented in FIG. 5, a common cap may be used. The two dispensing members 51, 51′, each respectively associated with one of the necks, are covered with a common cap. User actuation of the common cap simultaneously actuates the two dispensing members 51, 51′. User actuation of the common cap prevents independent actuation of the two dispensing members 51, 51′.

Although we have represented above, for the embodiment providing combined dispensing of two products, a dispensing system comprising two product outlets 52, 52′, a single product outlet could alternatively be provided, connected to each of the receptacles.

Alternatively, independent actuation of the two dispensing members 51, 51′ could be provided.

In this example, also represented is a decorative object 59, 60 provided in each of the receptacles.

As can be seen in FIG. 4b, the glass container body 5 may be manufactured using a mold similar to that of FIG. 4. If the neck 50 to be formed is placed at a location that does not allow withdrawing the punch 47 from the mold, a dedicated neck punch 63 is used, mounted to be movable relative to the mold for the body 45. In this case, it is one of the portions of the mold for the large opening 46 which incorporates the formation of the neck 50.

According to a variant of the dispensing system 4 of the embodiment of FIG. 5, necks are not necessarily made in the glass container bodies 5, 6, but in the sealing system 13 which is locally shaped for this purpose.

The variants described above for providing the dispensing system in the closure system may also be implemented in cases where the bottle has only a single receptacle (in which case only one neck is provided).

FIG. 8 proposes a bottle comprising a first glass container body 5, comprising a mouth.

The bottle comprises a first closure system 7 sealingly assembled to the mouth of the first glass container body 5.

The bottle comprises a second glass container body 6 sealingly assembled to the first closure system 7. The second glass container body 6 comprises two wide mouths. The mouths are opposite one another. The second glass container body is, for example, an annular cylinder open at both ends. The geometries of the inner and outer surfaces may differ from the example shown. The first mouth of the second glass container body is sealingly assembled to the first closure system 7. The assembly composed of the first closure system 7 and the first and second glass container bodies 5, 6 substantially corresponds to this assembly of parts as described in FIG. 6, except that this assembly comprises an open wide mouth.

The bottle comprises a second closure system 61 sealingly assembled to the second mouth of the second glass container body 6. The second closure system 61 may be implemented as a half-closure system 7, its sealing part then comprising a neck onto which a dispensing member 51 may be assembled. For this closure system, the locking system 36 encircling the sealing part may be replaced, where appropriate, by an assembled clasping part 64, for example clipped on from above, and having a through-opening 65 allowing passage of the neck 66 supporting the dispensing member 51, as represented in FIG. 9.

Thus, the second sub-bottle 106 is not solely composed of the glass container body 6, but comprises a glass container body 6 sealingly assembled to closure system 61.

The first and second closure systems and the glass container body are assembled in a permanent and non-removable manner so as to define at least one receptacle.

The product dispensing member provides access to a product that may be contained in the receptacle. Alternatively, if appropriate, it is possible to implement it elsewhere than in the second closure system, as described above for the other embodiments. As a variant, in what appears to be another invention, if the first closure system 7 is closed, one does not necessarily need to use a glass container body 5.

In the embodiments presented, the glass container bodies 5, 6 and the closure system(s) 3, 61 are assembled in a permanent and non-removable manner. “Permanent” and “non-removable” are understood to mean that the closure systems 3 cannot be detached from the glass container bodies under normal usage conditions.

1. A bottle wherein the bottle comprises:
a first sub-bottle comprising a first glass container body, comprising a first mouth,
a second sub-bottle, distinct and separate from the first sub-bottle, comprising a second glass container body that is distinct and separate from the first glass container body, and comprising a second mouth,
a closure system that is sealingly assembled in a permanent and non-removable manner to both the first mouth of the first glass container body and the second mouth of the second glass container body, the closure system and the first and second sub-bottles being assembled so as to define at least one receptacle,
a product dispensing system providing access to a product that may be contained in the at least one receptacle.

2. The bottle according to claim 1, wherein the closure system comprises a sealing system assembled to each of the first and second glass container bodies, and a locking system clasping the sealing system onto each of the first and second glass container bodies.

3. The bottle according to claim 2, wherein the sealing system is one piece.

4. The bottle according to claim 2, wherein the sealing system is assembled by at least clipping onto at least one among the first and second glass container bodies, and in particular onto each of the first and second glass container bodies.

5. The bottle according to claim 4, wherein the sealing system comprises a body and a clip portion that is elastically deformable relative to the body, and that provides an assembly contour, wherein said at least one among said first and second glass container bodies and in particular each of said first and second glass container bodies comprises a contour of a shape complementary to that of the assembly contour of the clip portion and wherein the contours engage to hold together the sealing system and said at least one among said first and second glass container bodies, and in particular each of said first and second glass container bodies.

6. The bottle according to claim 5, wherein the locking system (14) clasps the clip portion (16).

7. The bottle according to claim 3, wherein the first and second mouths are symmetrical to one another relative to a first plane of symmetry, and wherein the sealing system has a plane of symmetry that is coincident with the first plane of symmetry.

8. The bottle according to claim 1, wherein the first and second mouths are symmetrical to one another relative to a first plane of symmetry, and wherein the closure system has a plane of symmetry that is coincident with the first plane of symmetry.

9. The bottle according to claim 1, wherein the closure system and the first and second glass container bodies are assembled so as to define a single receptacle.

10. The bottle according to claim 1, wherein the closure system and the first and second glass container bodies are assembled so as to define at least first and second receptacles that are fluidtight relative to one another, the product dispensing system being arranged to provide access to a product that may be contained in the first and the second receptacle.

11. The bottle according to claim 10, wherein the product dispensing system is arranged to allow independent access to a product that may be contained in the first and the second receptacle.

12. The bottle according to claim 10, wherein the product dispensing system is arranged to allow joint access to a product that may be contained in the first and the second receptacle.

13. The bottle according to claim 10, wherein the product dispensing system is arranged to prevent independent access to products that may be contained in the first and the second receptacle.

14. The bottle according to claim 1, wherein the first and second glass container bodies have shapes that are symmetrical to each other relative to a plane of symmetry.

15. The bottle according to claim 1, wherein the first and second glass container bodies have shapes that are asymmetrical to each other relative to a plane of symmetry.

16. The bottle according to claim 1, wherein the product dispensing system provides access to a product that may be contained in the receptacle, through a dispensing opening, the mouths of the first and second glass container bodies having a cross-sectional area that is at least twice that of the dispensing opening.

17. The bottle according to claim 16, further comprising at least one solid object within the at least one receptacle, the object having dimensions that are between those of the cross-section of the mouth and the cross-section of the first dispensing opening.

18. A production method for a bottle, wherein the method comprises:
providing a first sub-bottle comprising a first glass container body, comprising a first mouth,
providing a second sub-bottle, distinct and separate from the first sub-bottle, comprising a second glass container body that is distinct and separate from the first glass container body, and comprising a second mouth,
sealingly assembling a closure system, in a permanent and non-removable manner, to the first mouth of the first glass container body and to the second mouth of the second glass container body, so as to define at least one receptacle, a product dispensing system being arranged to provide access to a product that may be contained in the at least one receptacle.

19. A production method for a bottle according to claim 18, wherein, when assembling the closure system:
a sealing system is assembled to each of the first and second glass container bodies, and
the sealing system is clasped onto each of the first and second glass container bodies by means of a locking system.

20. A production method for a bottle according to claim 19, wherein, when assembling the sealing system, the sealing system is clipped onto the first glass container body and, preferably the sealing system is then clipped onto the second glass container body.

21. A production method according to claim 17, wherein said first glass container body and/or said second glass container body are each provided by a pressing step in which a punch is moved out of a mold cavity, through the mouth.
